(19) United States
(12) Patent Application Publication
(10) Pub. No.: US 2022/0223178 A1
(43) Pub. Date: Jul. 14, 2022

(54) DATA DISASTER RECOVERY STORAGE DEVICE AND CARRIER

(71) Applicant: SHANGHAI SANLY DIGITAL TECHNOLOGY CO., LTD., Shanghai (CN)

(72) Inventors: Yunhai TENG, Shanghai (CN); Qu ZHANG, Shanghai (CN); Yisheng ZHU, Shanghai (CN); Jin CHEN, Shanghai (CN); Xinjia WANG, Shanghai (CN)

(21) Appl. No.: 17/617,437

(22) PCT Filed: May 21, 2020
(86) PCT No.: PCT/CN2020/091475

§ 371 Date: Dec. 8, 2021

(30) Foreign Application Priority Data
Jun. 11, 2019 (CN) 201910503811.6
Jun. 11, 2019 (CN) 201920875501.2

(51) Int. Cl. G11B 23/02

(52) U.S. Cl. CPC G11B 23/021

(57) ABSTRACT

Disclosed are a data disaster recovery storage device and a carrier. The data disaster recovery storage device comprises: a housing; a fire-resistant shell; a liner; an internal data line; and a memory. The memory is connected to the internal data line, and is suspended inside the liner. The water absorption resin is filled at the outer side of the memory. According to the present invention, a plurality of thermal insulation and heat-dissipation means are used for ensuring the safety of the memory during vehicle burning. The memory is mounted in a suspended manner, and is not in direct contact with other structures, which can effectively avoid direct heat conduction, and effectively perform shock absorbing. The invention utilizes the property that water boils at a constant temperature under the standard atmospheric pressure, and uses a method for storing water in a liner shell to ensure that the memory is not damaged at a certain external high temperature within a certain period of time.

This application claims the priority of Chinese patent application 2019105038116 filed on Jun. 11, 2019 and Chinese patent application 201920875012 filed on Jun. 11, 2019, the contents of which are incorporated herein by reference in their entirety.

### TECHNICAL FIELD

The present disclosure relates to a data disaster recovery storage device and a carrier.

### BACKGROUND

At present, some equipment in vehicles, such as driving recorders, generally use built-in hard disks or SD cards to store on-board data records. After the vehicle caught fire, crashed and fell into the water due to an accident, the built-in hard disk or SD card was damaged due to poor protection, so the driving data could not be read, and then the cause of the accident could not be judged.

In addition, the existing on-board fireproof storage device generally has only one layer of insulation material, and when the vehicle burns for too long or the temperature is too high, the built-in memory will be damaged and the data reading will fail. Chinese Patent Publication CN103118509A describes an on-board storage device. Although it has both thermal insulation material and constant temperature water shell, the memory is only fixed in the constant temperature water shell through vibration damping material, and its vibration damping effect needs to be verified. In addition, the memory is in contact with the metal shell of the water shell, and the heat can be transmitted to the memory through conduction.

### CONTENT OF THE PRESENT INVENTION

The technical problem to be solved in the present disclosure is for overcoming the defects that the fireproof storage device of the carrier in the prior art has poor thermal insulation effect, which is not conducive to storing the memory at high temperature, and has poor shock absorption effect, which easily leads to the memory damage, and hence providing a data disaster recovery storage devices and vehicles.

The present disclosure solves the above-mentioned technical problems through the following technical solutions:

A data disaster recovery storage device, characterized in that the data disaster recovery storage device comprises:

a liner filled with liquid;

an internal data cable extending outward from the liner;

a memory connected with the internal data cable and arranged inside the liner, the memory is in contact with the liquid in all directions, and the memory is fixed by a soft connection or a hard connection.

This solution not only adopts a variety of heat insulation and heat-dissipation means to ensure the safety of the memory during the combustion of the vehicle. Wherein the fire-resistant shell with thermal insulation can provide protection on the outside of the liner. In the liner, using the property of water boiling at a constant temperature under standard pressure, the method of storing water in the inner cavity of liner is adopted to ensure that the memory will not be damaged by the high temperature at a certain external high temperature for a certain period of time (Such as the test conditions stipulated by the JT/T794 standard).

Preferably, the inner and outer walls of the metal liner is coated with fire-resistant and thermal insulation coating. When the vehicle is burning, when the temperature further increases to more than 100° C., the coated fireproof coating expands to form a heat insulating layer, which reduces radiant heat while insulating heat.

Preferably, the memory and the internal data cable adopt a waterproof shell or waterproof setting to prevent liquid from entering, which will cause a short circuit.

Preferably, the liner is filled with a water absorption resin, and the resin forms a hydrogel after absorbing water, which prevents water loss and acts as a vibration isolation buffer. Wherein the water absorbing resin is in a hydrogel state after absorbing water, so as to ensure that the water in the liner is not easily lost. At the same time, the memory is installed in a suspended manner, and does not directly contact with other structures except the water absorption resin, which can effectively avoid direct heat conduction. The water absorbent resin can also provide buffer protection for the memory at the periphery, which can effectively avoid shock. In addition, the hydrogel can also absorb the heat generated. When the memory is normally electrified, preventing high internal temperature caused by the accumulation of heat in the liner.

When a vehicle crashes, the structure of the housing can withstand greater impact without being damaged. At the same time, the hydrogel state water absorption resin in the liner can also absorb the kinetic energy of the impact to protect the memory suspended inside. In case of high temperature caused by vehicle fire, the fire-resistant shell can isolate the external high temperature to protect the internal equipment. When the temperature further increases to more than 100° C. the water in the hydrogel starts to evaporate, and the water evaporation takes away the internal heat and keeps the temperature in the liner at about 100° C., thus protecting the memory.

Preferably, a fire-resistant shell is provided on the outer side of the liner, and the upper cover and the lower cover of the fire-resistant shell outside the liner are connected by concave-convex tenon and mortise structure to prevent heat from entering.

Preferably, the fire-resistant shell is provided with a cable slotting for the internal data cable to pass through the cable slotting.

Preferably, the outer part of the fire-resistant shell is hooped with a tungsten steel strip. The tungsten steel strip is directly hooped on the surface of the fire-resistant shell or hooped on a groove formed on the surface of the fire-resistant shell. The fire-resistant shell is further fastened with tungsten steel strip to prevent the separation of the fire-resistant upper cover and the fire-resistant lower cover of the fire-resistant shell caused by high-temperature expansion. Several grooves are arranged on the outside of the fire-resistant shell to facilitate the positioning and fixing of the tungsten steel strip.

Preferably, the data disaster recovery storage device further comprises a housing, the housing is installed with a data connection element, and the fire-resistant shell is installed inside the housing, and passes through the liner and the fire-resistant shell in sequence to connect with the data connection element, wherein the internal data cable is an FPC ribbon cable, and the data connection element is a USB interface board.

Preferably, the housing is cylindrical and includes a housing upper cover, an enclosure, and a housing base, and the two ends of the enclosure are respectively connected with the housing upper cover and the housing base by threads.

Preferably, the housing upper cover, the enclosure and the housing base are processed by stainless steel. Further, the shell can be selected from different materials and processed into any shape.

Preferably, a cable slotting is provided on liner, the internal data cable goes out of the liner through the cable slotting, and the gap between the internal data cable and the cable slotting is sealed and fixed by a sealing material. The sealing material for fixing the data line on the liner softens when heated. When the fire generates high temperature, the pressure generated by the vaporization of water in the liner pushes the sealing material away, so as to relieve the pressure outward through the cable slotting, so as to ensure that the steam is discharged in time and the internal temperature does not exceed 100° C. The sealing material can be silicone rubber.

Preferably, the liner is also provided with a pressure relief hole, which is sealed by a pressure relief valve. The pressure relief hole is reserved on the upper liner cover. When the fire produces high temperature, the pressure generated by the vaporization of water in the liner pushes away the pressure relief valve to release the pressure outward through the pressure relief hole, so as to ensure that the steam is discharged in time and the internal temperature does not exceed 100° C.

Preferably, a cable slotting is provided on the fire-resistant shell, the internal data cable goes out of the fire-resistant shell through the cable slotting, and the gap between the internal data cable and the cable slotting is sealed by a sealing material.

Preferably, the sealing material can be fireproof mud.

Preferably, the housing is provided with a cable hole, and the data connection element is respectively connected to the internal data cable and an external data cable, and the external data line passes out the housing through the cable hole.

Preferably, the housing is cylindrical and includes a housing upper cover, an enclosure, and a housing base, and the two ends of the enclosure are respectively connected with the housing upper cover and the housing base by threads. The housing adopts a cylindrical structure to withstand greater external force impact.

Preferably, the housing upper cover, the enclosure and the housing base are processed by stainless steel. The housing structure can further enhance the impact resistance effect.

Preferably, the fire-resistant shell includes a fire-resistant upper cover, a connecting ring, and a fire-resistant lower cover, and the fire-resistant upper cover and the fire-resistant lower cover are connected by the connecting ring.

Further, the upper and lower covers can also be connected to each other in a tenon and mortise structure.

Preferably, the joints of the fire-resistant shell can be sealed by fireproof mud.

Preferably, the liner includes an upper liner cover and a lower liner cover, and the connection between the upper liner cover and the lower liner cover is sealed by a sealing bar. The sealing bar can achieve waterproof effect.

Preferably, the storage is fixed by a waterproof shell, which is made of polytetrafluoroethylene. Polytetrafluoroethylene material has good resistance to high and low temperature, corrosion resistance and insulation.

A carrier, wherein it comprises the data disaster recovery storage device, and the data disaster recovery storage device is fixedly installed in the carrier.

The positive progressive effect of the invention is that the invention ensures the safety of the memory during vehicle combustion through a variety of thermal insulation and heat-dissipation means. The memory is mounted in a suspended manner, and is not in direct contact with other structures, which can effectively avoid direct heat conduction, and effectively perform shock absorbing. The invention utilizes the property that water boils at a constant temperature under standard atmospheric pressure, and adopts the method of storing water in the liner shell to ensure that the memory is not damaged in a certain external high temperature for a certain period of time.

### BRIEF DESCRIPTION OF THE DRAWINGS

FIG. 1 is a sectional structural diagram of a data disaster recovery storage device according to a preferred embodiment of the present invention.

FIG. 2 is a schematic diagram of an explosion structure of a data disaster recovery storage device according to a preferred embodiment of the present invention.

### DETAILED DESCRIPTION OF THE PREFERRED EMBODIMENT

The invention will be further described by way of embodiments, but the invention is not limited to the scope of the embodiments.

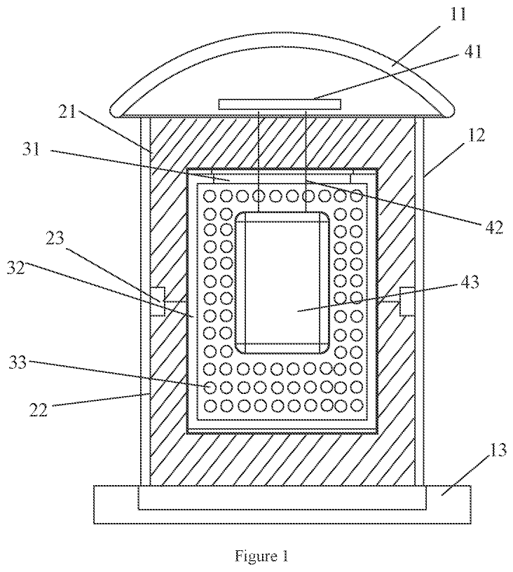

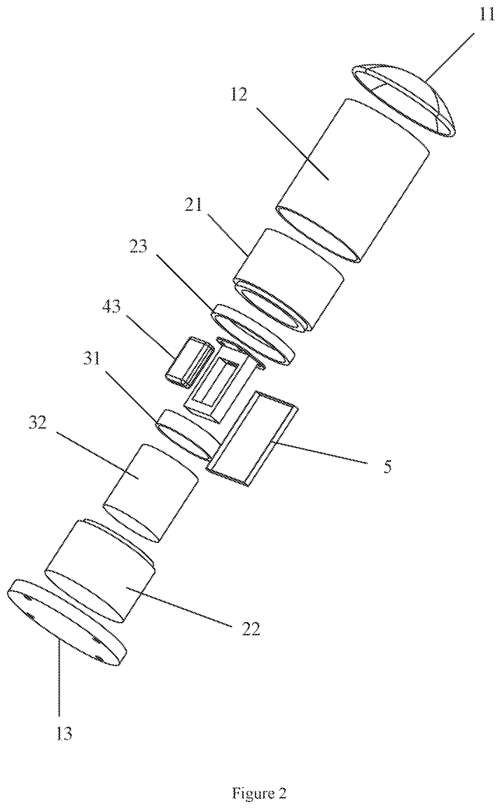

As shown in FIG. 1 and FIG. 2, this embodiment discloses a data disaster recovery storage device, wherein the data disaster recovery storage device includes a housing, a fire-resistant shell, a liner, and a memory 43 in order from the outside to the inside.

As shown in FIG. 1, this embodiment includes a housing, and a data connection element 41 is installed on the housing. As shown in FIG. 1 and FIG. 2, the housing of this embodiment is cylindrical and includes a housing upper cover 11, an enclosure 12, and a housing base 13. The two ends of the enclosure 12 are respectively connected with the housing upper cover 11 and the housing base 13 through threads. The housing adopts a cylindrical structure to withstand greater external force impact.

In this embodiment, the housing upper cover 11, the enclosure 12, and the housing base 13 are processed by stainless steel. The housing structure made of stainless steel can further enhance the impact resistance effect.

As shown in FIG. 1 and FIG. 2, this embodiment includes a fire-resistant shell made of fire-resistant material, and the fire-resistant shell is installed inside the housing. As shown in FIG. 1 and FIG. 2, in this embodiment, the fire-resistant shell includes a fire-resistant upper cover 21, a connecting ring 23, and a fire-resistant lower cover 22. The fire-resistant upper cover 21 and the fire-resistant lower cover 22 are connected to each other through the connecting ring 23.

As shown in FIG. 1 and FIG. 2, this embodiment includes a liner installed inside the fire-resistant shell, wherein the inside of the liner is filled with liquid, such as water, and the memory 43 is connected to the internal data cable 42 and is arranged inside the liner, and the memory 43 is in contact with the liquid in all directions, and the memory 43 is fixed by a soft connection or a hard connection. The memory 43 and the internal data cable 42 adopt a waterproof shell or waterproof setting to prevent liquid from entering, which will cause a short circuit.

There is also a water absorption resin 33 in the liner, and the water absorption resin 33 forms hydrogel after absorbing water. As shown in FIG. 1 and FIG. 2, in this embodiment, the liner includes an upper liner cover 31 and a lower liner cover 32, and the connection between the upper liner cover 31 and the lower liner cover 32 is sealed by a sealing bar. The sealing bar can achieve waterproof effect.

As shown in FIG. 1, this embodiment includes an internal data cable 42, which extends outward from the liner and successively passes through the liner and the fire-resistant shell to connect with the data connection element 41.

As shown in FIG. 1 and FIG. 2, this embodiment also includes a memory 43, which is connected with the internal data cable 42 and suspended inside the liner, and the water absorbent resin 33 is filled outside the memory 43.

This solution not only adopts a variety of thermal insulation and heat-dissipation means to ensure the safety of the memory 43 during the combustion of the vehicle. Wherein the fire-resistant shell can provide thermal insulation protection on the outside of the liner. In the liner, using the property of water boiling at a constant temperature under standard pressure, the method of storing water in the inner cavity of liner is adopted to ensure that the memory 43 will not be damaged at a certain external high temperature for a certain period of time (Such as the test conditions stipulated by the JT/T794 standard).

Wherein the water absorbing resin 33 is in a hydrogel state after absorbing water, so as to ensure that the water in the liner is not easily lost. At the same time, the memory 43 is installed in a suspended manner, and does not directly contact with other structures except the water absorption resin 33, which can effectively avoid direct heat conduction. The water absorbent resin 33 can also provide buffer protection for the memory 43 at the periphery, which can effectively avoid shock.

When a vehicle crashes, the structure of the housing can withstand greater impact without being damaged. At the same time, the hydrogel state water absorption resin 33 in the liner can also absorb the kinetic energy of the impact to protect the memory 43 suspended inside. In case of high temperature caused by vehicle fire, the fire-resistant shell can isolate the external high temperature to protect the internal equipment. When the temperature further increases to more than 100° C., the water in the hydrogel starts to evaporate, and the water evaporation takes away the internal heat and keeps the temperature in the liner at about 100° C., thus protecting the memory 43.

Preferably, a cable slotting is provided on the liner, the internal data cable 42 goes out of the liner through the cable slotting, and the gap between the internal data cable 42 and the cable slotting is sealed and fixed by a sealing material. The sealing material for fixing the data cable on the liner softens when heated. When the fire generates high temperature, the pressure generated by the vaporization of water in the liner pushes the sealing material away, so as to relieve the pressure outward through the cable slotting, so as to ensure that the steam is discharged in time and the internal temperature does not exceed 100° C.

In this embodiment, the sealing material used to seal the gap between the data cable 42 and the cable slotting is silicone rubber. In other optional embodiments, other existing sealing materials with proximity properties can also be used. Sealing is achieved under normal conditions. In case of fire, water vapor can be discharged as long as the sealing material can be softened at high temperature and pushed away by the air pressure in the liner.

In this embodiment, the liner is also provided with a pressure relief hole, which is sealed by a pressure relief valve. The pressure relief hole is reserved on the upper liner cover 31. When the fire produces high temperature, the pressure generated by the vaporization of water in the liner pushes away the pressure relief valve to release the pressure outward through the pressure relief hole, so as to ensure that the steam is discharged in time and the internal temperature does not exceed 100° C.

In this embodiment, a cable slotting is provided on the fire-resistant shell, the internal data cable 42 goes out of the fire-resistant shell through the cable slotting, and the gap between the internal data cable 42 and the cable slotting is sealed by a sealing material. The sealing material can be fireproof mud.

In this embodiment, the housing is provided with a cable hole, and the data connection element 41 is respectively connected to the internal data cable 42 and an external data cable, and the external data cable goes out the housing through the cable hole. The joints of the fire-resistant shell can be further sealed by fireproof mud.

As shown in FIG. 2, in this embodiment, the outer part of the fire-resistant shell is hooped with a tungsten steel strip 5, which is directly hooped on the surface of the fire-resistant shell or hooped on grooves formed on the surface of the fire-resistant shell. The fire-resistant shell is further fastened with tungsten steel strip 5 to prevent the separation of the fire-resistant upper cover 21 and the fire-resistant lower cover 22 of the fire-resistant shell caused by high-temperature. Several grooves are arranged on the outside of the fire-resistant shell to facilitate the positioning and fixing of the tungsten steel strip 5. The fire-resistant upper cover 21 and the fire-resistant lower cover 22 are connected by a connecting ring 23 or a concave-convex tenon and mortise structure to prevent heat from entering.

In this embodiment, the inner surface of the liner is coated with fire-resistant and thermal insulation coating. In the event of a fire, when the temperature of the liner is further increased to more than 100° C. after the evaporation of the water in the liner, the fireproof coating applied on the inner wall of the liner expands to form a heat insulating layer, which reduces radiant heat while insulating heat.

In this embodiment, the memory 43 can use 1 to 2 EMMC chips, whose storage and working temperature can reach 150° C. to ensure reliable recording. The memory 43 is further fixed by a waterproof shell made of polytetrafluoroethylene. The Polytetrafluoroethylene material has good resistance to high and low temperature, corrosion resistance and insulation.

In this embodiment, the internal data cable 42 is an FPC ribbon cable, and the data connection element 41 is a USB interface board. The external data cable can further be a USB data cable.

This embodiment also discloses a carrier, wherein the carrier includes a data disaster recovery storage device, and the data disaster recovery storage device is fixedly installed in the carrier. The data disaster recovery storage device can be further fixed on the floor of the carrier. The recording equipment on the carrier, such as a vehicle-mounted video recording device or a driving recorder, can be connected to an external data cable through a standard USB port, so as to connect to the data disaster recovery storage device.

The carriers of this embodiment include but are not limited to vehicles, ships, aircrafts and other equipment and scenes that need data protection in the event of fire and collision.

When installing the data disaster recovery storage device of this embodiment, first the packaged memory 43 is fixed on the upper liner cover with screws, and the internal data cable 42 is passed through the cable slotting of upper liner cover. Inject water into the liner, and then add water absorbent resin particles into the liner, and the upper liner cover 31 is fixed with the lower liner cover 32 before the particles absorbing water swell into a hydrogel. The connection between the upper liner cover 31 and the lower liner cover 32 is waterproofed with a sealing bar, and the place where the internal data cable passes through shall be sealed with silicone rubber.

After the liner is assembled, it is installed into the fire-resistant shell made of fireproof material. The internal data cable 42 is drawn from the cable slotting of the fire-resistant upper cover 21, and the fire-resistant upper cover 21 and the fire-resistant lower cover 22 are connected by the connecting ring 23, and further sealed with fireproof mud. The fire-resistant shell is reserved with groove or grooves for fixing the tungsten steel strip 5, and the tungsten steel strip 5 passing through the groove or grooves fixes the fire-resistant upper cover 21 and the fire-resistant lower cover 22, so that the fire-resistant shell forms a complete sealing structure.

The enclosure 12 is rotated into the housing base 13, and the data connection element 41 is installed in the cavity formed by the housing upper cover 11. The external data cable that is pulled out can be connected to the data connection element 41 by welding, and then the internal data cable 42 is connected to the data connection element 41, and the internal data cable is led out from the cable hole reserved in the housing upper cover 11, and finally the housing upper cover 11, the fire-resistant shell and the housing base 13 are connected to complete the assembly.

When in use, the data disaster recovery storage device is fixed on the vehicle by screws, and the external data cable is connected with the USB dump interface of the vehicle video recorder or the driving recorder, and the driving data can be stored in the memory in real time.

When a vehicle crashes, the cylindrical housing and shell structure can withstand greater impact without being damaged. At the same time, the hydrogel in the liner can also absorb the kinetic energy of the impact to protect the memory 43 suspended inside. In case of high temperature caused by vehicle fire, the fire-resistant shell can isolate the external high temperature to protect the internal equipment. When the temperature is further increased to more than 100° C., the fireproof coating applied on the inner wall of the liner expands to form a heat insulation layer to prevent heat from entering the tank body and the water in the hydrogel starts to evaporate. The pressure generated by the evaporation of water will lift the pressure relief valve and the sealant on the upper liner cover to take away the internal heat and keep the temperature in the liner at about 100° C., thereby protecting the memory safety.

The invention ensures the safety of the memory during vehicle combustion through a variety of thermal insulation and heat-dissipation means. The memory is mounted in a suspended manner, and is not in direct contact with other structures, which can effectively avoid direct heat conduction, and effectively perform shock absorbing. The invention utilizes the property that water boils at a constant temperature under standard atmospheric pressure, and adopts the method of storing water in the liner shell to ensure that the memory is not damaged in a certain external high temperature for a certain period of time.

Although the specific embodiments of the present invention are described above, those skilled in the art should understand that this is only an example, and the protection scope of the present invention is defined by the appended claims. Those skilled in the art can make various changes or modifications to these embodiments without departing from the principle and essence of the present invention, but these changes and modifications all fall within the protection scope of the present invention.

1. A data disaster recovery storage device, wherein the data disaster recovery storage device comprises:
A liner filled with liquid;
An internal data cable extending outward from the liner;
A memory connected with the internal data cable and arranged inside the liner, the memory is in contact with the liquid in all directions, and the memory is fixed by a soft connection or a hard connection.

2. The data disaster recovery storage device according to claim 1, wherein the data disaster recovery storage device further comprises a housing, the inner and outer walls of the liner and the housing are coated with fire-resistant and thermal insulation coating, and the liner is filled with a water absorption resin, and the resin absorbs water to form a hydrogel to prevent water loss and play the role of heat absorption and vibration isolation and buffering.

3. The data disaster recovery storage device according to claim 1, wherein the memory and the internal data cable adopt a waterproof shell or waterproof setting to prevent liquid from entering which will cause a short circuit.

4. The data disaster recovery storage device according to claim 1, wherein a pressure relief hole is provided on the liner, and the pressure relief hole is sealed by a pressure relief valve, when the fire produces high temperature, the pressure generated by the vaporization of water in the liner pushes away the pressure relief valve to release the pressure outward through the pressure relief hole, so as to ensure that the steam is discharged in time and the internal temperature does not exceed 100° C.

5. The data disaster recovery storage device according to claim 1, wherein a fire-resistant shell is provided on the outer side of the liner, and an upper cover and a lower cover of the fire-resistant shell outside the liner are connected by a connecting ring or concave-convex tenon and mortise structure to prevent heat from entering.

6. The data disaster recovery storage device according to claim 5, wherein the fireresistant shell is provided with a cable slotting for the internal data cable to pass through the cable slotting.

7. The data disaster recovery storage device according to claim 5, wherein the outer part of the fire-resistant shell is hooped with a high temperature resistant cable tie.

8. The data disaster recovery storage device according to claim 5, wherein the data disaster recovery storage device further comprises a housing, the housing is installed with a data connection element, and the fire-resistant shell is installed inside the housing, and the internal data cable passes through the liner and the fire-resistant shell in sequence to connect with the data connection element.

9. The data disaster recovery storage device according to claim 8, wherein the housing is cylindrical and includes a housing upper cover, an enclosure, and a housing base, and the two ends of the enclosure are respectively connected with the housing upper cover and the housing base by threads, and the housing upper cover, the enclosure and the housing base are processed by stainless steel.

10. A carrier, wherein it comprises the data disaster recovery storage device according to claim 1, and the data disaster recovery storage device is fixedly installed in the carrier.

11. The data disaster recovery storage device according to claim 2, wherein the memory and the internal data cable adopt a waterproof shell or waterproof setting to prevent liquid from entering which will cause a short circuit.

12. The data disaster recovery storage device according to claim 2, wherein a pressure relief hole is provided on the liner, and the pressure relief hole is sealed by a pressure relief valve, when the fire produces high temperature, the pressure generated by the vaporization of water in the liner pushes away the pressure relief valve to release the pressure outward through the pressure relief hole, so as to ensure that the steam is discharged in time and the internal temperature does not exceed 100° C.

13. The data disaster recovery storage device according to claim 3, wherein a pressure relief hole is provided on the liner, and the pressure relief hole is sealed by a pressure relief valve, when the fire produces high temperature, the pressure generated by the vaporization of water in the liner pushes away the pressure relief valve to release the pressure outward through the pressure relief hole, so as to ensure that the steam is discharged in time and the internal temperature does not exceed 100° C.

14. The data disaster recovery storage device according to claim 2, wherein a fireresistant shell is provided on the outer side of the liner, and an upper cover and a lower cover of the fire-resistant shell outside the liner are connected by a connecting ring or concave-convex tenon and mortise structure to prevent heat from entering.

15. The data disaster recovery storage device according to claim 3, wherein a fireresistant shell is provided on the outer side of the liner, and an upper cover and a lower cover of the fire-resistant shell outside the liner are connected by a connecting ring or concave-convex tenon and mortise structure to prevent heat from entering.

16. The data disaster recovery storage device according to claim 4, wherein a fireresistant shell is provided on the outer side of the liner, and an upper cover and a lower cover of the fire-resistant shell outside the liner are connected by a connecting ring or concave-convex tenon and mortise structure to prevent heat from entering.

17. The data disaster recovery storage device according to claim 6, wherein the data disaster recovery storage device further comprises a housing, the housing is installed with a data connection element, and the fire-resistant shell is installed inside the housing, and the internal data cable passes through the liner and the fire-resistant shell in sequence to connect with the data connection element.

18. The data disaster recovery storage device according to claim 7, wherein the data disaster recovery storage device further comprises a housing, the housing is installed with a data connection element, and the fire-resistant shell is installed inside the housing, and the internal data cable passes through the liner and the fire-resistant shell in sequence to connect with the data connection element.
